(19) United States
(12) Patent Application Publication
(10) Pub. No.: US 2011/0198006 A1
(43) Pub. Date: Aug. 18, 2011

(54) Pneumatic Tire

(75) Inventor: Yoshinori Asayama, Osaka (JP)

(73) Assignee: Toyo Tire & Rubber Co., Ltd., Osaka (JP)

(21) Appl. No.: 13/011,966

(22) Filed: Jan. 24, 2011

(30) Foreign Application Priority Data
Feb. 16, 2010 (JP) 2010-031479

(51) Int. Cl. B60C 9/18; B60C 11/00

(52) U.S. Cl. 152/209.18

(57) ABSTRACT

In a pneumatic tire having a tread rubber which is provided with a plurality of main grooves extending along a tire circumferential direction, and a land portion comparted by the main grooves, a belt layer which is embedded in the tread rubber, and a belt reinforcing layer which is arranged in an outer periphery of the belt layer, the belt reinforcing layer has a reinforcement laminated portion constructed by at least three layers in an inner region of the land portion, and the reinforcement laminated portion is structured such that a depth from a tread surface to an outermost layer is smaller than a groove depth of the main groove, and the outermost layer covers a side of an end portion of a layer positioned in an inner periphery thereof.

### BACKGROUND OF THE INVENTION

1. Field of the Invention

The present invention relates to a pneumatic tire which can well achieve a compatibility of a traveling performance on an ice road surface and a traveling performance on a dry road surface, and is particularly useful for a studless tire.

2. Description of the Related Art

Generally, in a studless tire, a comparatively soft rubber is used in a tread. Accordingly, a land portion tends to moderately lean at a braking time or a cornering time, and based on an edge effect generated in accordance therewith, it is possible to enhance a traveling performance on an ice road surface (hereinafter, refer to as an ice performance) having a low coefficient of friction.

In the meantime, in recent years, an opportunity of traveling on the dry road surface by the studless tire is increased under the influence of a warm winter caused by a global warming, there is such a tendency that the traveling performance on the dry road surface (hereinafter, refer to as a dry performance) is demanded in addition to the ice performance. The dry performance can be improved by using a comparatively hard rubber in the tread, or setting a sipe density low, however, the ice performance is lowered on the other hand. Accordingly, there is strongly desired a countermeasure by which the ice performance and the dry performance are well compatible, independently from a rubber compounding and the sipe density.

In Japanese Unexamined Patent Publication No. 2006-103397, there is described a pneumatic tire in which a narrow reinforcing layer is arranged at positions of at least both sides of a belt layer. However, this structure only suppress a diameter growth at a traveling time of a pneumatic tire by means of the reinforcing layer, and it is thought that this structure hardly has an improving effect relating to a compatibility of the ice performance and the dry performance. In other words, in order to improve the dry performance while securing the ice performance, it is necessary to suppress the land portion from leaning by a way which depends neither on the rubber hardness nor on the sipe density, however, this tire does not disclose the structure for this necessity.

In Japanese Unexamined Patent Publication No. 11-291713, there is described a pneumatic tire which is provided in an outer side of a belt layer, with a band layer having a high density portion which is positioned in an inner side of a rib-like portion of a land portion, and a low density portion which is positioned in an inner side of a vertical groove, and there is disclosed a structure in which three band plies are formed in an overlapping manner as the high density portion. However, even in this tire, the effect of suppressing the land portion from leaning is not sufficient, a contribution to the compatibility of the ice performance and the dry performance is thought to be small. Further, there is fear that a separation beginning at an end portion of the band ply is generated. First of all, the tire is used as a racing tire, and does not suggest a solving means for the problem mentioned above in the studless tire.

### SUMMARY OF THE INVENTION

The present invention has been made in view of the above circumstances, and an object of the present invention is to provide a pneumatic tire which can achieve a compatibility of an ice performance and a dry performance.

The object can be achieved by the following present invention. That is, the present invention provides a pneumatic tire comprising a tread rubber provided with a plurality of main grooves extending along a tire circumferential direction, and a land portion comparted by the main grooves, a belt layer embedded in the tread rubber, and a belt reinforcing layer arranged in an outer periphery of the belt layer, wherein the belt reinforcing layer has a reinforcement laminated portion constructed by at least three layers in an inner region of the land portion, and the reinforcement laminated portion is structured such that a depth from a tread surface to an outermost layer is smaller than a groove depth of the main groove, and the outermost layer covers a side of an end portion of a layer positioned in an inner periphery thereof.

In this pneumatic tire, since the belt reinforcing layer has the reinforcement laminated portion in the inner region of the land portion, it is possible to improve a rigidity of the land portion. Further, since the reinforcement laminated portion is constructed by at least three layers, the depth from the tread surface to the outermost layer is smaller than the groove depth of the main groove, and the outermost layer covers the side of the end portion of the layer positioned in the inner periphery thereof, the groove wall of the main groove is effectively reinforced. As a result, even in a case where the rubber compounding and the sipe density are set so as to be advantageous for the ice performance, it is possible to suppress the land portion from leaning, and it is possible to well achieve the compatibility of the ice performance and the dry performance. Further, since the outermost layer covers the side of the end portion of the layer positioned in the inner periphery thereof, it is possible to prevent the separation beginning at the end portion from being generated.

In the present invention, it is preferable that the outermost layer covers the sides of the end portions of the layer positioned in the inner periphery thereof, in both sides in a width direction of the reinforcement laminated portion. In accordance with such a structure, it is possible to improve a separation resisting performance as well as it is possible to suppress the land portion from leaning by reinforcing the groove wall of the main groove in both sides in the width direction of the reinforcement laminated portion.

In the present invention, it is preferable that the outermost layer of the reinforcement laminated portion is structured such as to enwrap the end portion of the layer positioned in the inner periphery thereof. In accordance with such a structure, it is possible to effectively enhance the separation resisting performance by blocking a progress of the separation beginning at the end portion of the layer positioned in the inner periphery.

### BRIEF DESCRIPTION OF THE DRAWINGS

FIG. 1 is a half cross sectional view of a tire meridian and shows an example of a pneumatic tire in accordance with the present invention;

FIG. 2 is an enlarged view showing a substantial part of the tire in FIG. 1;

FIG. 3a is a substantial part cross sectional view showing a reinforcement laminated portion in another embodiment in accordance with the present invention;

FIG. 3b is a perspective view showing an example of a cross section in FIG. 3a;

FIG. 4 is a substantial part cross sectional view showing a reinforcement laminated portion in another embodiment in accordance with the present invention;

FIGS. 5(a) to 5(e) are views showing a modified example of an enwrapping structure of the reinforcement laminated portion; and

FIG. 6 is a half cross sectional view of a tire meridian in another embodiment in accordance with the present invention.

### DETAILED DESCRIPTION OF THE PREFERRED EMBODIMENTS

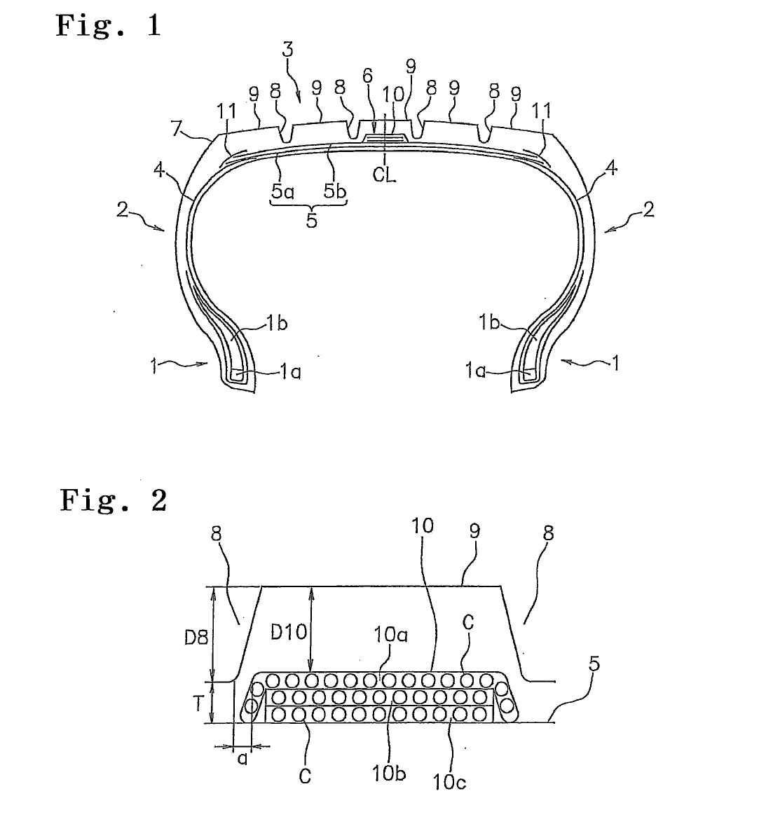

A description will be given below of an embodiment in accordance with the present invention with reference to the accompanying drawings. A pneumatic tire shown in FIG. 1 is provided with a pair of annular bead portions 1, side wall portions 2 extending from the bead portions 1 to an outer side in a tire diametrical direction, and a tread portion 3 continued into outer peripheral side ends of the side wall portions 2. A carcass layer 4 runs into the bead portion 1 from the tread portion 3 via the side wall portion 2, and is folded back in such a manner as to pinch a bead core 1a and a bead filler 1b. The carcass layer 4 in the present embodiment has an interrupted structure in which the carcass layer is interrupted in a tire width direction at the tread portion 3, however, the present invention is not limited to this.

A tread rubber 7 constructing an outer peripheral side portion of the tread portion 3 is provided with a plurality of main grooves 8 which extend along a tire circumferential direction, and a land portion 9 which is comparted by the main grooves 8. The land portion 9 is constructed by a rib which extends continuously in the tire circumferential direction, or a plurality of blocks. In the latter case, the land portion 9 is segmented in the tire circumferential direction by a lateral groove which extends in a direction intersecting the main grooves 8. In the light of sufficiently achieving an edge effect so as to enhance an ice performance, a sipe is formed as occasion demands on a surface of the land portion 9.

The belt layer 5 is embedded in the tread rubber 7, and is arranged in an outer periphery of the carcass layer 4 at the tread portion 3. Belt plies 5a and 5b are formed by rubber coating steel cords which are arranged at an angle of gradient between 10 and 60 degrees with respect to the tire circumferential direction, and the belt layer 5 is constructed by laminating at least two belt plies (two belt plies 5a and 5b in the present embodiment) in such a manner that their cords are inverted to each other. The cords may be made of an organic fiber such as a polyester, a rayon, a nylon, an aramid or the like.

A belt reinforcing layer 6 is arranged in an outer periphery of the belt layer 5, and the tread rubber 7 is provided in an outer periphery of them. The belt reinforcing layer 6 has a reinforcement laminated portion 10 constructed by three layers in an inner region of the land portion 9. Further, in the present embodiment, the belt reinforcing layer 6 has a pair of reinforcement end portions 11 covering both end portions of the belt layer 5, independently from the reinforcement laminated portion 10. The reinforcement end portion 11 holds down a flapping of the end portion of the belt layer 5 so as to improve a durability.

As shown in an enlarged manner in FIG. 2, the reinforcement laminated portion 10 is structured such that a depth D10 from the tread surface to an outermost layer 10a is smaller than a groove depth D8 of the main groove 8, and the outermost layer 10a covers a side of end portions of layers 10b and 10c which are positioned in an inner periphery thereof. Accordingly, a groove wall of the main groove 8 is effectively reinforced, it is possible to suppress a leaning of the land portion 9 while advantageously setting a rubber compounding and a sipe density for the ice performance, and it is possible to well achieve a compatibility of the ice performance and the dry performance. In the light of securing the above operation and effect, it is preferable that a difference between the groove depth D8 and the depth D10 is equal to or more than 1.0 mm.

Further, since the outermost layer 10a covers the side of the end portions of the layers 10b and 10c which are positioned in the inner periphery of them, it is possible to prevent a separation from being generated beginning at the end portion so as to improve a separation resisting performance. In the present embodiment, since the covering structure is applied to both sides in a width direction of the reinforcement laminated portion 10, it is possible to obtain an effect of suppressing the leaning of the land portion 9 and an effect of improving the separation resisting performance, in both sides thereof.

The reinforcement laminated portion 10 is constructed by three layers or more at least partly, and may be constructed by, for example, four layers or more. Accordingly, it is easy to secure a height of the reinforcement laminated portion 10, and it is possible to suitably reinforce a root portion of the land portion 9 by making the depth D10 smaller than the groove depth D8. On the other hand, since a rubber thickness T from the belt layer 5 to a groove bottom of the main groove 8 is about 2 mm, and a diameter of the cord included in the reinforcement laminated portion is generally less than 1 mm, it is impossible to suitably secure the height by a reinforcement laminated portion having two layers or less.

It is preferable that a height of the reinforcement laminated portion 10 does not exceed TWI (a tread wear indicator (not shown)). TWI is a projection which is provided in a groove bottom of the main groove 8 for informing of a tire replacement time due to a wear, and is provided, for example, at a height of 1.6 mm from the groove bottom.

The belt reinforcing layer 6 is constructed by a cord C which extends substantially in parallel to the tire circumferential direction and is coated by a rubber. As a raw material of the cord C, an organic fiber such as a nylon, an aramid, a polyester, a rayon or the like can be exemplified, a diameter thereof is, for example, between 0.5 and 0.8 mm, and it is possible to employ a structure having the equivalent physical property to that of the cord included in the general belt reinforcing layer. The belt reinforcing layer 6 may be formed by winding one rubber-coated cord C or a small-width band-like ply constructed by a plurality of rubber coated cords C, spirally along the tire circumferential direction.

Since the reinforcement laminated portion 10 is structured such that the outermost layer 10a covers the side of the end portions of the layers 10b and 10c as mentioned above, it has a portion extending along a groove wall in the vicinity of the groove bottom of the main groove 8, and the cord C can be arranged even at a height between the layers (in other words, between the layer 10a and the layer 10b, and/or between the layer 10b and the layer 10c). Accordingly, the reinforcing effect of the root portion of the land portion 9 is enhanced, and a steering stability is improved at a cornering time or the like.

A distance a in a tire width direction from the groove wall of the main groove 8 to the reinforcement laminated portion 10 is preferably between 1.0 and 3.0 mm, and is more preferably between 1.0 and 1.5 mm. If this distance a exceeds 3.0 mm, there is a tendency that an effect of improving a rigidity of the land portion 9 by the reinforcement laminated portion 10 becomes smaller, and if this distance a is less than 1.0 mm, the reinforcement laminated portion 10 comes too close to the groove wall, whereby there is a risk of being an obstacle in a forming step of the main groove 8 at a curing time of the tire.

The number of the main grooves 8 formed in the tread rubber 7 is not particularly limited, however, in the present embodiment, there is shown an example in which two main grooves 8 are formed in one side, respectively, with respect to a tire equator CL, totally four main grooves 8 are formed. In this case, the land portion 9 is constructed by a center land portion including the tire equator CL, a pair of mediate land portions positioned in both sides thereof, and a pair of shoulder land portions positioned in an outermost side. The reinforcement laminated portion 10 may be arranged in at least one land portion 9. However, since the center land portion comparatively highly contributes to the dry performance, it is preferable to arrange the reinforcement laminated portion 10 at least in the inner region of the center land portion, such as the present embodiment.

Since the pneumatic tire in accordance with the present invention can well achieve the compatibility of the ice performance and the dry performance by achieving the above operation and effect, it is useful particularly as a studless tire. In order to easily generate the suitable leaning of the land portion 9 in the studless tire, a rubber hardness (measured value of a type A durometer of JISK6253) of the tread rubber 7 is preferably between 40 and 60 degrees, and more preferably between 45 and 55 degrees.

The belt reinforcement layer 6 may have a wide layer wholly covering the belt layer 5. And a structure in which the number of the wide layer mentioned above is one that is called as a one-cap reinforcement structure. For example, the layer 10c just above the belt layer 5 may be wider than the belt layer 5 so as to serve as the reinforcement end portion 11, or the reinforcement laminated portion 10 may be constructed by the wide layer 10c and the layers 10a and 10b. In this case, the outermost layer 10a covers only the end portion of the layer 10b, however, at least one inner peripheral layer which is covered in its side of the end portion by the outermost layer 10a may be provided. Further, such as examples 1 to 3 mentioned below, the one-cap reinforcement structure may be employed, and the reinforcement laminated portion 10 mentioned above may be arranged in an outer periphery thereof. In this case, the reinforcement laminated portion is constructed by four layers.

As mentioned above, it can be thought that the present invention is structured such that the reinforcement laminated portion 10 is arranged even in the inner region of the groove bottom of the main groove 8, however, it is preferable that the belt reinforcement layer 6 is arranged while avoiding the inner region of the groove bottom of the main groove 8. The reinforcement of the inner region of the groove bottom of the main groove 8 does not contribute to the dry performance so much, and in order to suppress the leaning of the land portion 9, it is sufficient to arrange the reinforcement laminated portion 10 in the inner region of the land portion 9. Further, in order to execute the forming step of the main groove 8 without trouble at the curing time of the tire, the above structure is advantageous. The reinforcement laminated portion 10 in this case comes to the structure having two or more layers of narrow layers in the inner periphery of the outermost layer.

The present invention is not limited to the above embodiments at all, but can be variously modified and changed within the scope of the present invention. The tread pattern formed on the tread surface can be appropriately changed in correspondence to an intended use and a condition for use. Further, the tread rubber is not limited to a single layer, but may be constructed by a multi-layer such as a cap base structure in which a cap rubber is laminated on an outer periphery of a base rubber.

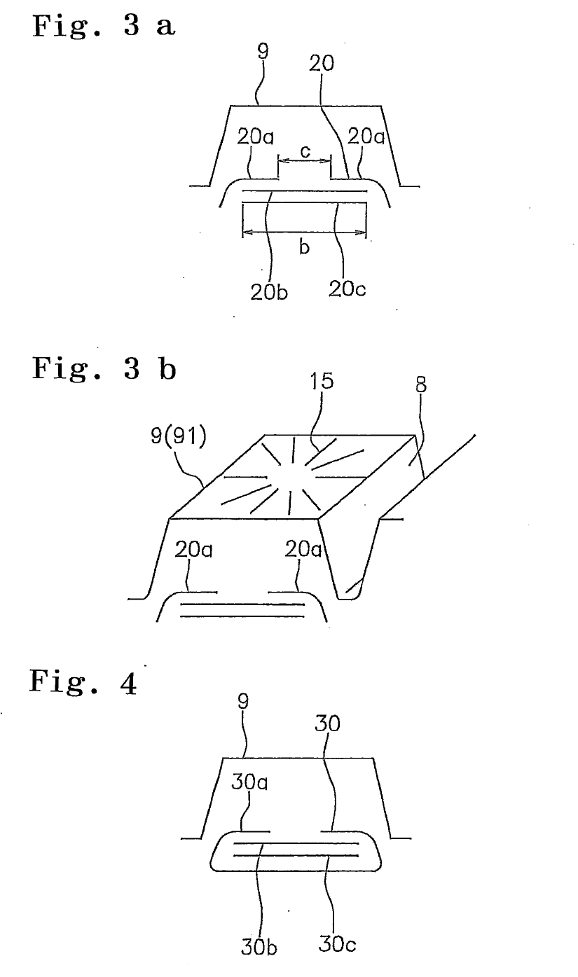

A description will be given of another embodiment of the reinforcement laminated portion which can be used in the pneumatic tire in accordance with the present invention. A reinforcement laminated portion 20 shown in FIG. 3a corresponds to an example in which an outermost layer 20a is segmented in a center in a width direction thereof, and a rate c/b of a segmentation distance c with respect to a width b of a layer 20c is, for example, between 0.1 and 0.6. Further, only one of the two divided outermost layers 20a may be arranged, and in this case, a rigidity can be improved by targeting at an inner side or an outer side at a time of being installed to the vehicle in the land portion 9. Each of them is structured such that the reinforcement laminated portion 20 is constructed by three layers including the layers 20a, 20b and 20c.

In the reinforcement laminated portion 20 as shown in FIG. 3a, it is preferable to homogenize an arrangement of the outermost layer 20a to a distribution of the sipe. In other words, in the case of forming a radial sipe 15 which radially extends from a center portion and has no sipe in the center portion, in a block 91 serving as the land portion 9, as exemplified in FIG. 3b, there is a tendency that a rigidity becomes high in the center portion of the block 91, however, since the outermost layer 20a is segmented in the center portion, it is possible to achieve a uniformity of the rigidity so as to improve a steering stability. The sipe is formed as the radial shape in FIG. 3b, however, is not limited to this. Further, since there is a tendency that the rigidity of the center portion becomes high even in the block in which the Sipe is not provided in the surface, it is possible to obtain the same effect of improving the steering stability based on the arrangement of the outermost layer 20a.

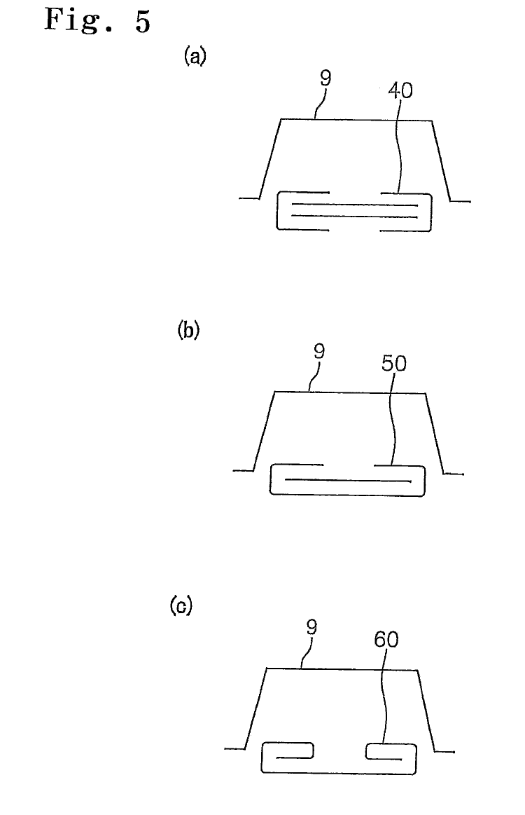

A reinforcement laminated portion 30 shown in FIG. 4 is structured such that an outermost layer 30a enwraps end portions of layers 30b and 30c which are positioned in an inner periphery thereof, and is constructed by four layers. In accordance with this structure, it is possible to securely inhibit a separation from making progress beginning at the end portions of the layers 30b and 30c, and it is possible to effectively enhance a separation resisting performance. As a modified example of the enwrapping structure mentioned above, there can be listed up reinforcement laminated portions 40, 50 and 60 shown in FIGS. 5(a) to 5(c). The reinforcement laminated portion 40 is the example which is constructed by four layers, and the reinforcement laminated portions 50 and 60 are the examples which are constructed by three layers. These enwrapping structure may be applied only to one side in the width direction of the reinforcement laminated portion.

Further, in the present invention, each of the layers constructing the reinforcement laminated portion may not have the same width, but, for example, in the reinforcement laminated portion 10 in FIG. 2, the widths of the layer 10b and the layer 10c may be different. Further, in a part of the layer constructing the reinforcement laminated portion, an angle of gradient of the cord may be different from the other layer. For example, in the reinforcement laminated portion 10 in FIG. 2, the cord C of the layer 10b may extend in the tire width direction. In the above reinforcement laminated portion 10, since a lateral rigidity of the land portion 9 is improved, it is possible to suppress a wiping so as to improve the ice performance, by arranging this in the inner region of the shoulder land portion.

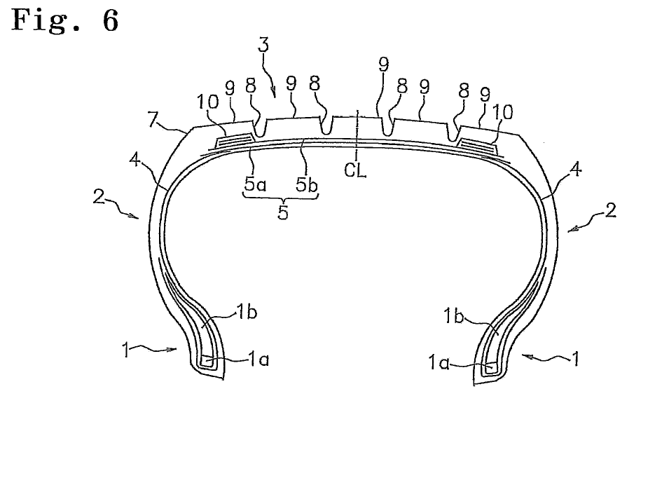

In the above embodiment, there is shown the example in which the reinforcement laminated portion 10 is arranged only in the inner region of the center land portion, however, the present invention is not limited to this, but it can be arranged in the mediate land portion or the shoulder land portion. FIG. 6 is an example in which the reinforcement laminated portion 10 is arranged in the inner region of a pair of shoulder land portions.

### EXAMPLES

A description will be given below of examples which specifically show the structure and the effect of the present invention. Items of evaluation in the examples were measured as mentioned below.

(1) Ice Performance

Tires to be tested were installed to an actual car (a domestic sedan car) so as to be traveled on an ice road surface, and a braking distance was measured at a time of applying a braking force from an approaching speed 40 km/h and actuating an ABS. An inverse number of the measured value is expressed as an index number by setting a result of a comparative example 1 to 100, and the greater the numerical value indicates, the more the ice performance (particularly, the braking performance) is excellent.

(2) Dry performance

The tires to be tested were installed to the actual car mentioned above, a turning travel, the braking or the like were executed on a test course corresponding to the dry road surface, and a steering stability, a cornering performance and a braking performance were evaluated based on a subjective test by a driver. A result is evaluated by an index number by setting a result of the comparative example 1 to 100, and the greater the index number is, the more the dry performance is excellent.

(3) Separation Resisting Performance

15000 km traveling test was carried out by using an indoor drum testing machine provided with a drum having a diameter of 1.7 m, setting a pneumatic pressure to 180 kPa, setting a test speed to 80 km/h, and increasing a tire load in increments of specified times from 85% of JIS provision so as to travel finally at 140% thereof. After the traveling test, the separation of the belt reinforcement layer was searched by dismounting the tire, the tire having no separation was evaluated as “◯”, and the tire in which the separation is generated was evaluated as “x”.

### Comparative Examples 1 to 3

In the tire (size: 195/65R15) having the structure shown in FIG. 1, the tire which is not provided with the belt reinforcing layer was set to a comparative example 1. Further, a comparative example 2 was structured such as to have the same constructions as those of the comparative example 1 except an employment of the one-cap reinforcement structure in which the belt layer is covered by one layer of wide ply, and a rubber hardness of the tread rubber being set 5 degrees higher. Further, a comparative example 3 was structured such as to have the same constructions as those of the comparative example 1 except an employment of the one-cap reinforcement structure in the same manner, and a sipe density being set 0.02 mm/mm² smaller. The sipe density is a value obtained by dividing a total of the lengths of the sipes by an area of a land portion tread surface.

### Examples 1 to 4

An example 1 was structured such as to have the same constructions as those of the comparative example 1 except an employment of the one-cap reinforcement structure in the same manner as the comparative examples 2 and 3, and the reinforcement laminated portion shown in FIG. 2 being arranged in the inner region of the center land portion. Further, an example 2 was structured such as to have the same constructions as those of the example 1 except the reinforcement laminated portion being constructed by the structure shown in FIG. 3a. Further, an example 3 was structured such as to have the same constructions as those of the example 1 except the reinforcement laminated portion being constructed by the structure shown in FIG. 4. An example 4 was structured such as to have the same constructions as those of the example 1 except an employment of a pair of reinforcement end portions covering both ends of the belt layer as shown in FIG. 1, in place of the one-cap reinforcement structure.

### Comparative Example 4

A comparative example 4 was structured such as to have the same constructions as those of the example 1 except the outermost layer of the reinforcement laminated portion being set to have the same width as the layer positioned in the inner periphery thereof. Results of evaluation will be shown in Table 1.

TABLE 1

| | | Comparative | Comparative | Comparative | | | | | Comparative |
|---|---|---|---|---|---|---|---|---|---|
| | | example 1 | example 2 | example 3 | Examples 1 | Examples 2 | Examples 3 | Examples 4 | example 4 |
| ice performance | | 100 | 90 | 95 | 100 | 100 | 100 | 100 | 100 |
| dry | steering | 100 | 110 | 105 | 108 | 108 | 108 | 103 | 105 |
| performance | stability | | | | | | | | |
| | cornering | 100 | 110 | 103 | 110 | 110 | 110 | 103 | 106 |
| | performance | | | | | | | | |
| | braking | 100 | 110 | 106 | 110 | 105 | 105 | 102 | 109 |
| | performance | | | | | | | | |

| | | | | | | | | |
|---|---|---|---|---|---|---|---|---|
| separation resisting | — | — | — | ∘ | ∘ | ∘ | ∘ | x |
| performance | | | | | | | | |

From Table 1, it is known that dry performance can be improved respectively by making the tread rubber hard in the comparative example 2, and by making the sipe density low in the comparative example 3, however, the ice performance is lowered on the contrary. Further, in the comparative example 4 in which the reinforcement laminated portion is arranged, the dry performance can be improved while maintaining the ice performance, however, the separation tends to be generated in the periphery of the end portion of each of the layers. On the contrary, in the examples 1 to 4, the dry performance is improved without deteriorating the ice performance, and the compatibility of both the performances can be well achieved. Further, in the example 3, the separation resisting performance is improved by employing the enwrapping structure.

What is claimed is:

1. A pneumatic tire comprising:
a tread rubber provided with a plurality of main grooves extending along a tire circumferential direction, and a land portion comparted by the main grooves;
a belt layer embedded in the tread rubber; and
a belt reinforcing layer arranged in an outer periphery of the belt layer,
wherein the belt reinforcing layer has a reinforcement laminated portion constructed by at least three layers in an inner region of the land portion, and the reinforcement laminated portion is structured such that a depth from a tread surface to an outermost layer is smaller than a groove depth of the main groove, and the outermost layer covers a side of an end portion of a layer positioned in an inner periphery thereof.

2. The pneumatic tire according to claim 1, wherein the outermost layer covers the sides of the end portions of the layer positioned in the inner periphery thereof, in both sides in a width direction of the reinforcement laminated portion.

3. The pneumatic tire according to claim 1, wherein the outermost layer of the reinforcement laminated portion is structured such as to enwrap the end portion of the layer positioned in the inner periphery thereof.
